(19) United States
(12) Patent Application Publication
(10) Pub. No.: US 2013/0132237 A1
(43) Pub. Date: May 23, 2013

(54) SYSTEM AND METHOD DETERMINING AND DISPLAYING ACTIONS TAKEN ON DIGITAL CONTENT

(71) Applicant: Barnesandnoble.com llc, New York, NY (US)

(72) Inventors: Matthew PALLAKOFF, Mountain View, CA (US); Harold Edward COHN, Incline Village, NV (US)

(73) Assignee: BARNESANDNOBLE.COM LLC, New York, NY (US)

(21) Appl. No.: 13/677,042

(22) Filed: Nov. 14, 2012

Related U.S. Application Data
(60) Provisional application No. 61/563,431, filed on Nov. 23, 2011.

(51) Int. Cl. G06Q 30/06

(52) U.S. Cl. CPC G06Q 30/0623; G06Q 30/0641; G06Q 30/0633
USPC 705/26.61; 705/27.1; 705/26.8

(57) ABSTRACT

A method, system and non-transitory computer-readable medium are provided for determining and displaying actions taken on content displayed on one or more maps provided on a display screen of an electronic device. The actions taken with respect to the content include actions performed by users in the system. The one or more maps include geographic maps and social maps.

### FIELD OF THE INVENTION

The present invention generally relates to systems and methods for reading digital content, and more particularly to systems and methods for allowing users to discover new content.

### BACKGROUND OF THE INVENTION

The Internet is a worldwide network of computers linked together by various hardware communication links all running a standard suite of protocols known as TCP/IP (transmission control protocol/Internet protocol). The growth of the Internet over the last decade has been explosive, fueled in the most part by the widespread use of software viewers known as browsers and HTTP (hypertext transfer protocol) which allow a simple GUI (graphical user interface) to be used to communicate over the Internet. Browsers generally reside on the computer used to access content on the Internet, i.e. the client computer. HTTP is a component of TCP/IP and provides users access to files of various formats using a standard page description language known as HTML (hypertext markup language), and more recently XML (extensible markup language) and XHTML (extensible hypertext markup language), a reformulation of HTML into XML. The collection of servers on the Internet using HTTP has become known as the “World Wide Web” or simply the “Web.”

As known and appreciated in the art, there are presently millions of Web pages with various content. Tools have been developed to allow the user to search these Web pages to obtain the various Web pages having the various content of interest. One way to locate the desired content is to use a “search engine” which will search for Web pages having a particular keyword or key words.

One of the primary applications of the Web has been shopping, i.e., the purchase of content such as electronic books. Virtually every major commercial “bricks and mortar” merchant has established a Web site for the showcase and sale of their content. Further many publishers, distributors and merchants sell their content directly over the Web. Finally, a plethora of online merchants, not previously existing in the bricks and mortar world, have come into existence. As a result, virtually every form of content is available for purchase over the Web from a plurality of merchants.

Although this situation has increased the efficiency of markets by permitting shoppers to readily discover content from a plurality merchants without the need to travel physically to the merchant locations, the volume of content that can be found on the Web can be overwhelming.

### SUMMARY OF THE INVENTION

The present invention operates in connection with a reader for digital publications, such as electronic books, eBooks, or electronic magazines or newspapers. The invention enhances a user's ability to discover new content for reading. In one aspect of the invention, a map is presented, such as an image of the United States of America, or a globe, or even a simple text listing that illustrates content, e.g., books magazines or newspapers that are being purchased, recommended or lent, in semi-real time. User can click on those items of content on the map or list to see the details of that content and execute a purchase.

### BRIEF DESCRIPTION OF THE DRAWINGS

For the purposes of illustrating the present invention, there is shown in the drawings a form which is presently preferred, it being understood however, that the invention is not limited to the precise form shown by the drawings in which like reference characters refer to like parts throughout, and in which:

FIG. 1 illustrates an exemplary action map in accordance with a first aspect of the present invention;

FIG. 2 illustrates a listing of content, including content being acted on, according to a second aspect of the present invention;

FIG. 3 illustrates the content list in a landscape format;

FIG. 4 depicts an action map in landscape format;

FIG. 5 illustrates an exemplary system according to the present invention; and

FIG. 6 illustrates the components of an exemplary device.

### DETAILED DESCRIPTION OF THE INVENTION

One object of the present is to enhance the ability of a user to discover new content for reading. This object is accomplished by displaying to a user a dynamic scrolling and/or animated stream of books, magazines or newspapers being purchased, recommended, or lent in semi-real-time. User could then click on those items to see details and purchase them. In a preferred embodiment, the content being loaned or recommended or otherwise being acted on is displayed on a geographical map.

As used herein, a “user” may be a single user or a group of users. As used herein, the term “user” (or “user device”, “client device”, “network-connected device” or “device”) can refer to any electronic apparatus configured for receiving control input and configured to send commands or data either interactively or automatically to other devices. As used herein, the term “method” refers to one or more steps performed at least by one electronic or computer-based apparatus. Steps may be performed in any order without departing from the scope of the invention.

In a preferred embodiment, the maps or lists are displayed in the context of a “Shop” application executing on a user's electronic reader. The Shop application is the application where a user typically browses content for purchase. However, the maps or lists of the present invention can also be displayed in connection with other applications. For example, the maps or lists could be displayed from the user's Home screen or displayed in widgets or even as live wallpaper on the user's device. Live wallpaper can accept clicks on items in the wallpaper, and thus the user can click on the item of content and learn more details.

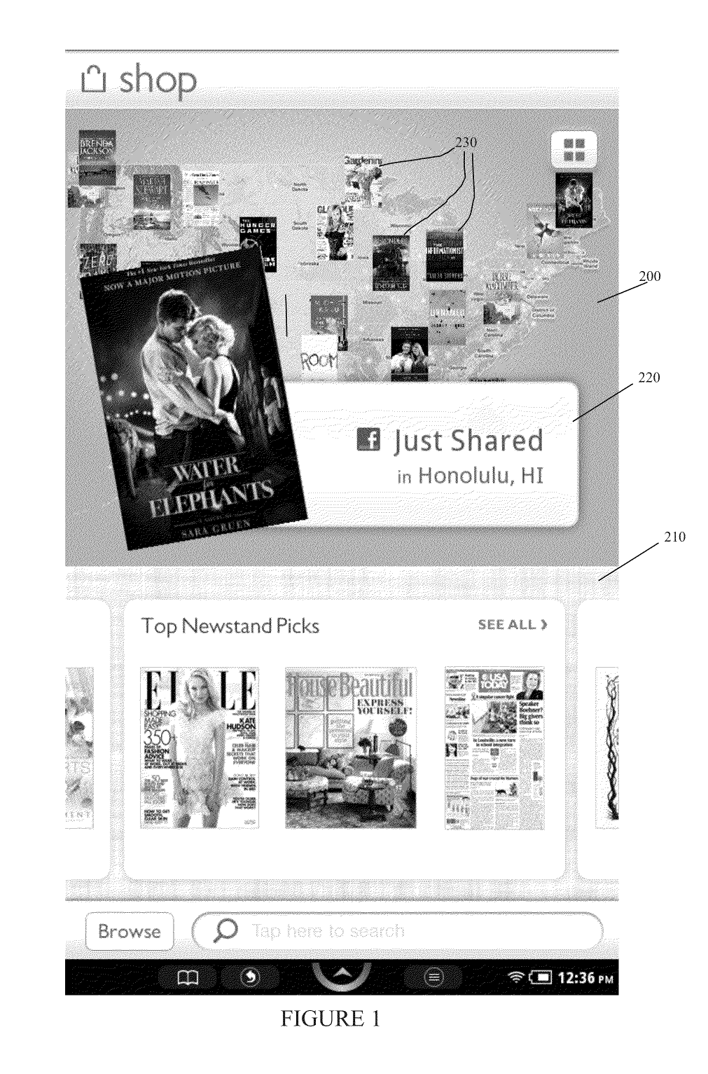

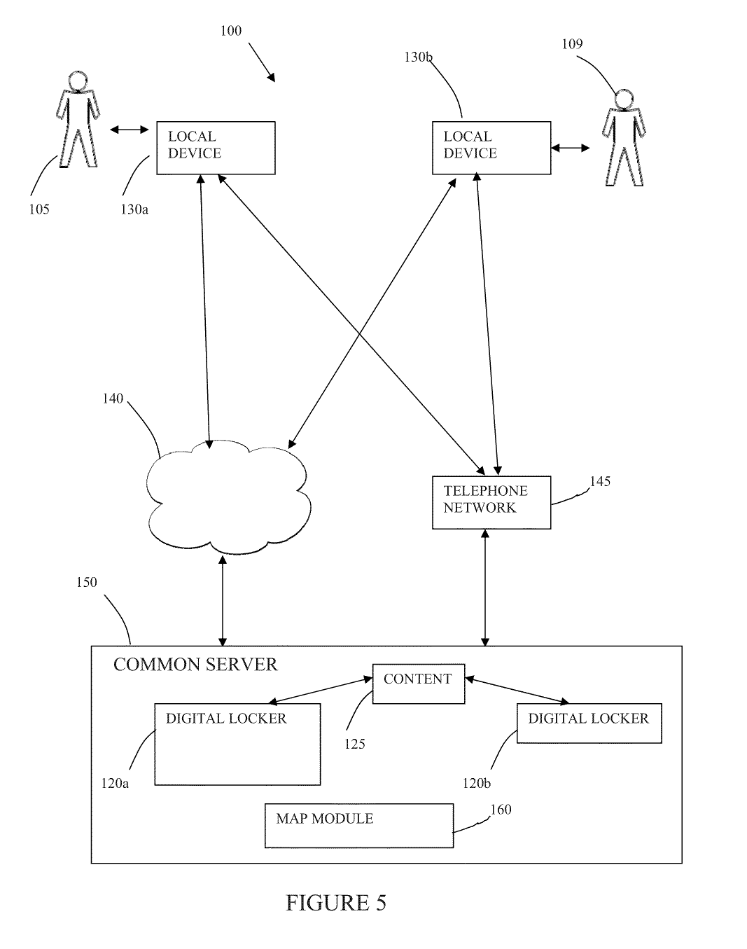

FIG. 1 illustrates an action map 200 in accordance with a first aspect of the present invention. As described above, the map 200 can be displayed in connection with a Shop application executing on a device 210 of the user. The term “Action Maps” is sometimes used herein to describe the systems and methods of the present invention. The Action Maps of the present invention can be displayed anywhere, including on the web, on a TV, on a phone or on in-store display. As shown in FIG. 1, the present invention displays a map 200 of the United States showing an animated list of covers of items 230 being purchased, loaned, recommended or having some other action taken with respect to them, preferably by some other users of the system. The system is described in more detail below in connection with FIG. 5. For example, as depicted in FIG. 1, the book Water far Elephants was just, in near real time, shared by a user in Honolulu Hawaii. Although the present invention preferably tracks the action of users of the system with respect to their actions regarding content, the present invention can also track the actions of customers in retail locations, or on the web, outside of the system, e.g., purchases of content by non-registered users at a .com site.

Taking into account privacy concerns, the events reported in the Action Maps can be anonymous but do not have to be. For example, if users opt-in or do not opt-out of participation in Action Maps, the system can also display their profile picture and name or handle from Facebook or the social network portion of the present system. These levels of identification are preferably configurable by the user.

The user can click or tap on the cover of the book 220 or the cover of any other hook 230 displayed on the map 200 to get more information about the book, and potentially purchase and download the book to her device 210.

The term ‘near real time’ is used because of the reality of volume of data being processed and the potential of overwhelming the user and the system. In order to reduce traffic in the system and avoid confusion of the user by a rapidly changing interface, one embodiment of the present invention fetches updates every minute. This fetching would cease when the activity by the user is paused or her device 210 goes into standby mode.

As further described below, the activity related to content being presented to the user can be filtered by any number of criteria, such as genre or author of the content, by geographic location, or by the relationship of user to the other users acting on the content, e.g., only display content being acted on by the user's friends. Filtering criteria may be combined. For example, the activities displayed on a first user's device could be limited to purchases, lending offers, and recommendations by the user's friends and friends-of-friends of items related to things that the first user has purchased or viewed in the last three months. The concept of “related to” can be defined, for example, as being in the same genre or subgenre or common themes. Additionally, when too many actions, or transactions, are available to attractively or efficiently display on a given device, the system may display only a subset of those transactions on that device, such as every fifth transaction. Alternatively, if a set of filtering criteria limits the displayed content too much, such that too few actions of interest appears, the system may dynamically relax the filter constraints to allow more actions or transactions to appear.

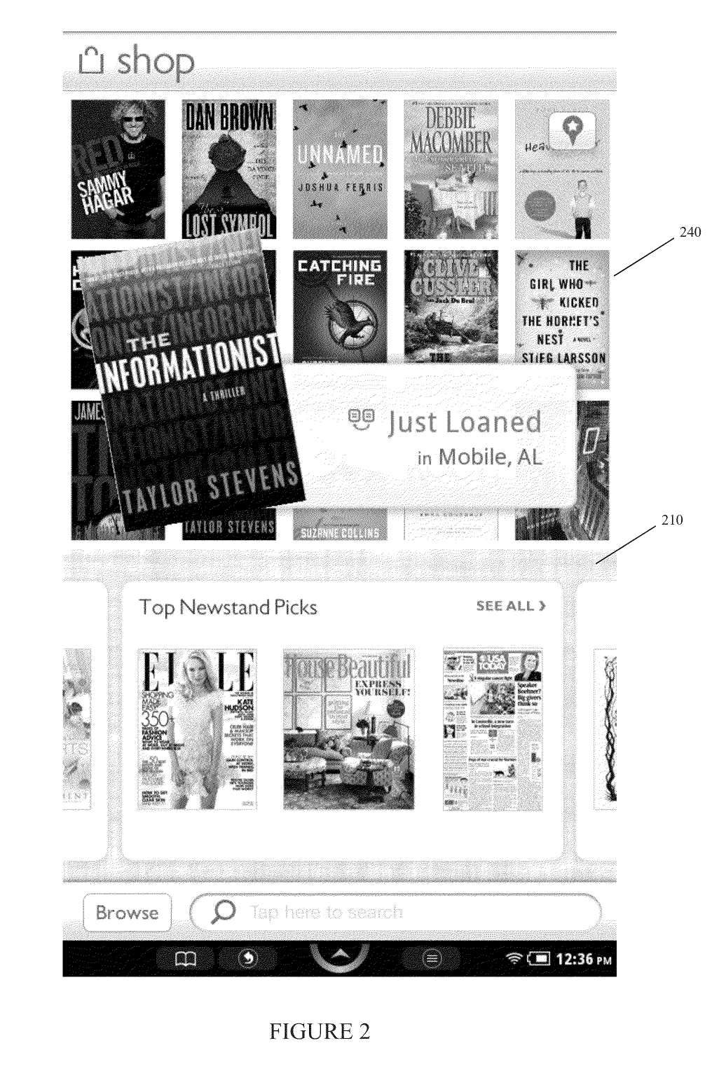

FIG. 2 illustrates a listing 240 of content, including content being acted on, according to a second aspect of the present invention. In contrast to the map 200 illustrated in FIG. 1, the content being acted on can be displayed to the user in the form of a graphical list 240, and in the exemplary embodiment illustrated in FIG. 2, in the form of the covers of the content.

In addition to the specific actions of loans, sharing, purchases or recommendations, the maps and lists of the present invention can also indicate other actions with respect to specific content, such as a book trending on Twitter.

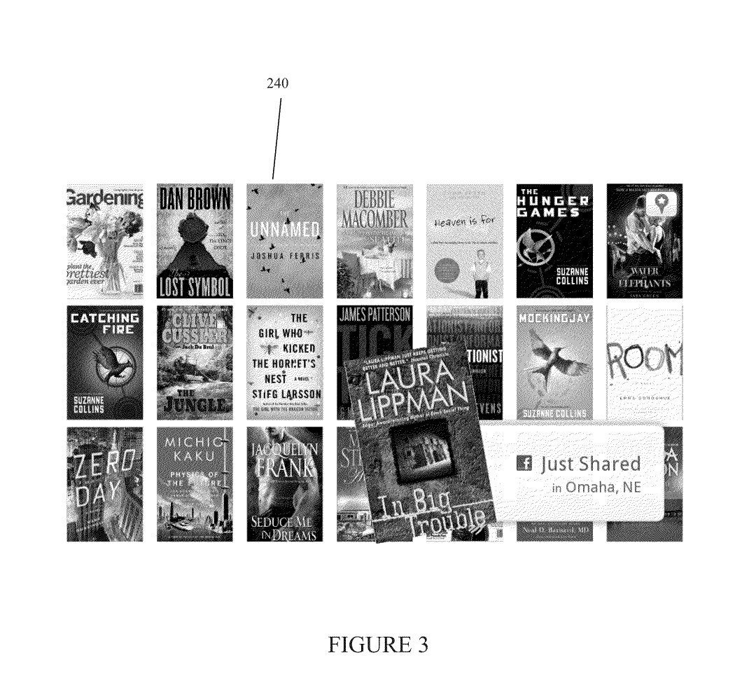

FIG. 3 illustrates the content list 240 in a landscape format.

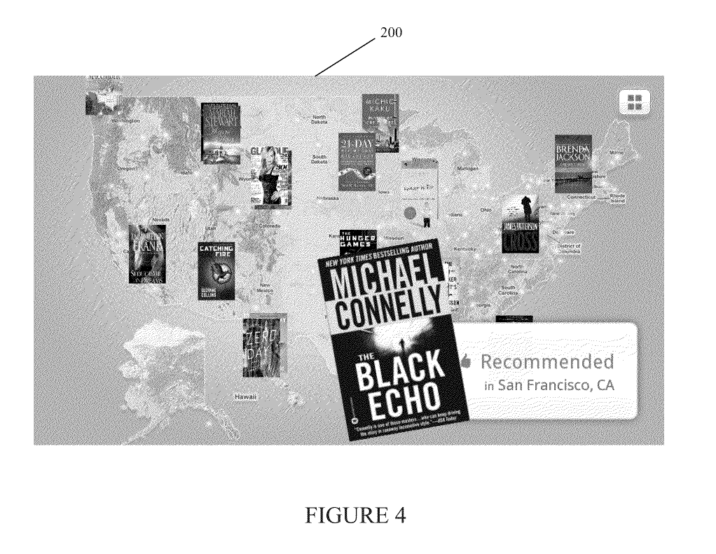

FIG. 4 depicts an action map 200 in landscape format.

FIG. 5 shows components of an action map system according to the present invention. User 105 is an authorized user of system 100 and uses her local device 130a for the reading of digital content and interacting with other users 109. Many of the functions of system 100 of the present invention are carried out on server 150. As appreciated by those skilled in the art, many of the functions described herein can be divided between the server 150 and the user's local device 130a. Further, as also appreciated by those skilled in the art, server 150 can be considered a “cloud” with respect to the user and her local device 130a. The cloud can actually be comprised of several servers performing interconnected and distributed functions. For the sake of simplicity in the present discussion, only a single server 150 will be described. As appreciated by those skilled in the art, the server 150 includes control circuitry such as at least one processor, memory, storage devices and communication circuitry for performing server operations. The user 105 can connect to the server 150 via the Internet 140, a telephone network 145 (e.g., wirelessly through a cellphone network) or other suitable electronic communication means. User 105 has an account on server 150, which authorizes user 105 to use system 100.

Associated with the user's 105 account is the user's 105 digital locker 120a located on the server 150. As further described below, in the preferred embodiment of the present invention, digital locker 120a contains links to copies of digital content 125 previously purchased (or otherwise legally acquired) by user 105. However, it is not required that a user have a locker or an account with the operator of the system to view the dynamic Action Map information of the present invention.

Indicia of rights to all copies of digital content 125 owned by user 105, including digital content 125, is stored by reference in digital locker 120a. Digital locker 120a is a remote online repository that is uniquely associated with the user's 105 account. As appreciated by those skilled in the art, the actual copies of the digital content 125 are not necessarily stored in the user's locker 120a, but rather the locker 120a stores an indication of the rights of the user to the particular content 125 and a link or other reference to the actual digital content 125. Typically, the actual copy of the digital content 125 is stored in another mass storage (not shown). The digital lockers 120 of all of the users 105, 109 who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the server 150 can contain millions of files 125 containing digital content. It is also contemplated that the server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

Also contained in the user's digital locker 120a is her contacts list. In a preferred embodiment, the user's contact list will also indicate if the contact is also an authorized (registered) user of the system 100 with his or her own account on server 150. This information can be used by map module 160 to display to a user 105, her “friends,” contacts that are currently lending, being loaned, buying or recommending content.

User 105 can access his or her digital locker 120a using a local device 130a. Local device 130a is an electronic device such as a personal computer, an e-book reader, a smart phone or other electronic device that the user 105 can use to access the server 150. In a preferred embodiment, the local device has been previously associated, registered, with the user's 105 account using user's 105 account credentials. Local device 130a provides the capability for user 105 to download user's 105 copy of digital content 125 via his or her digital locker 120a. After digital content 125 is downloaded to local device 130a, user 105 can engage with the downloaded content locally, e.g., read the book, listen to the music or watch the video.

In a preferred embodiment, local device 130a includes a non-browser based device interface that allows user 105 to initiate the mapping functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120a using the Internet 140, local device 130a also includes a web account interface. Web account interface provides user 105 with browser-based access to his or her account and digital locker 120a over the Internet 140.

User 109 is also an authorized user of system 100. As with user 105, user 109 has an account with server 150, which authorizes user 109 to use system 100. As appreciated by those skilled in the art, the number of users 105, 109 that employ the present invention at the same time is only limited by the scalability of server 150. As with user 105, user 109 can access his or her digital locker 120b using her local device 130b. In a preferred embodiment, local device 130b is a device that user 109 has previously associated, registered, with his or her account using user's 109 account credentials. Local device 130b allows user 109 to download copies of his digital content 125 from digital locker 120b. User 109 can engage with downloaded digital content 125 locally on local device 130b.

The local devices 130a and 130b should he capable of supplying enough data to identify their locations, at least approximately. These devices are often connected to the cloud, most likely wirelessly, especially when using the mapping function of the present invention. Accordingly, the user's IP addresses or the IDs and strengths of the wireless networks the users can “see” can often be used to identify their approximate locations. However, other ways to locate users are possible, including GPS receivers in some devices, or actual address or zip code entry by the user. As users read their digital books, the Map Module 160 tracks users, and location information, so that it can either construct these “Map of Readers” images on demand for each client, or feed the clients the data they need to construct the maps locally. As described above, the actions non users of the system can also be tracked to create the maps of the present invention, e.g., customers at physical retail locations or at online retail locations.

The Map Module 160 can be designed to filter the data so that a user only sees activity with respect to content that meet certain criteria, such as content being acted on by other people within this person's social network, e.g., “friends,” or only display content in specific genres of books, or other criteria. This can help reduce the amount of data delivered to the clients, and reduce the visual “noise” seen by the user. The designer may choose to give each user control over some or all of those filters, such as the ability to only see which of his “friends” or book club mates have been acting on content. On the other hand, a designer may also choose to let each user see a map of the whole world of all other readers who have acted on content.

As appreciated by those skilled in the art, all of the users whose interactions, e.g., purchases, recommendations, etc., are displayed on the map are connected to a common sever, network or servers or network, as described above, which allows the users' actions and, optionally, locations to be displayed to others. In preferred embodiments, each user can control which information is shared with others, at least with respect to any information that might allow others to identify the user.

As noted above, there are several ways for the system to determine a user's approximate location, such as an IP address of the user's device 130, or having the user self identify her location, or using subsystems that identify approximate locations based on which wireless signals are visible to the device, or other such mechanisms.

The present invention allows the user filter what/who is being displayed on the map. In one embodiment, the user can entirely turn off her visibility, or limit it to just her contacts. The user is able to filter who and what they see—for example, toggle between “everyone in the world (who has enabled the feature),” “just friends,” “just people in or near my city,” “just people in my book club,” “just books,” “just mystery books” or “just books by author A. Smith.”

Map module 160 has interface with other modules of server 150 to collect the activity data with respect to content as described above. This collected data is then processed and transmitted to the users 105, 109 of the system that have active maps or lists being displayed.

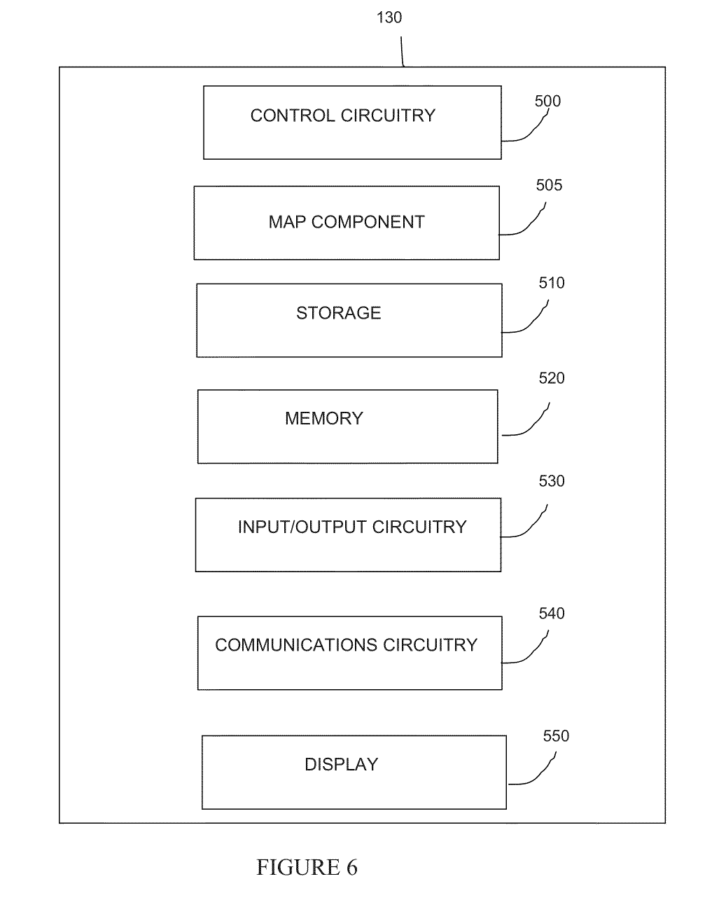

FIG. 6 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in this Figure, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Map component 505 at least the software and hardware for generating the map for display on electronic device 130. As described above, the map component can simply display a map that is transmitted from the remote server 150, or can actually generate the map itself, based on the data sent to it by the remote server 150. Further, the map component 505 is capable of performing the filtering functions as described above (e.g., filtering based on contacts).

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in this Figure as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, which is incorporated in electronics device 130. In some embodiments, the display circuitry can include a coder/decoder (Codec) to convert digital media data into analog signals. For example, the display circuitry or other appropriate circuitry within electronic device can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in FIG. 6 to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

For the sake of brevity, it should be understood that certain structures and functionality, or aspects thereof, of embodiments of the presently disclosed invention that are evident from the illustrations of the figures have not been necessarily restated herein.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A method for tracking actions taken with respect to content in a system, the system including a central server and a plurality of user devices, the user devices performing the actions on the content, the method comprising:
on the central server
a. receiving action data from a specific user device, the action data containing an identification of a specific action taken with respect to a specific item of content;
b. determining a geographic location of the specific user device;
c. associating the geographic location with the action data for the specific user device;
d. storing the action data and the associated geographic data;
e. repeating acts a-d for additional action data from additional user devices;
f. generating display data, the display data including the action data and the associated geographic location; and
g. transmitting the display data to at least one user device.

2. The method according to claim 1, further comprising:
on the at least one user device:
displaying the display data, the display data including a representation of respective specific items of content, respective actions taken with respect to the specific items of content and the geographic location of respective specific user devices

3. The method according to claim 2, wherein the act of displaying the display data further comprises displaying the display data on a geographic map.

4. The method according to claim 2, wherein the act of displaying the display data further comprises displaying the display data as a list.

5. The method according to claim 2, wherein the act of displaying the display data further comprises animating the display data, wherein the animating, over time, highlights different representations of respective specific items of content, respective actions taken with respect to the specific items of content and the geographic location of respective specific user devices.

6. The method according to claim 2, further comprising:
connecting to the central server; and
accessing a shopping application, wherein the act of displaying the display data occurs in association with the shopping application.

7. The method according to claim 6, further comprising:
receiving a selection of one of the representation of respective specific items of content; and
performing a purchase transaction with respect to the selected specific item of content.

8. The method according to claim 7, further comprising:
storing a link to a copy of the purchased specific item of content in a digital locker associated with the at least one user device; and
downloading a user copy of the purchased specific item of content to the at least one user device.

9. The method according to claim 2, wherein act of displaying the display data occurs on a home screen, a widget or as live wallpaper on the at least one user device.

10. The method according to claim 1, further comprising:
filtering the display data.

11. The method according to claim 10, wherein the filtering act further comprises identifying ones of the specific user devices that are associated with the at least one user device.

12. The method according to claim 1, wherein the specific action taken with respect to a specific item of content include at least one of purchasing, recommending, sharing and lending the specific item of content.

13. A system operable with a plurality of user devices, the system comprising:
a memory that includes instructions for operating the processor;
a storage device that contains items of digital content; and
control circuitry coupled to the memory and coupled to the storage device, the control circuitry executing the instructions and is operable to:
a. receive action data from a specific user device, the action data containing an identification of a specific action taken with respect to a specific item of content;
b. determine a geographic location of the specific user device;
c. associate the geographic location with the action data for the specific user device;
d. store the action data and the associated geographic data;
e. repeat acts a-d for additional action data from additional user devices;
generate display data, the display data including the action data and the associated geographic location; and
transmit the display data to at least one user device.

14. The system according to claim 13, wherein the control circuitry executing the instructions and is further operable to filter the display data.

15. The system according to claim 14, wherein the control circuitry executing the instructions and is further operable to perform the filtering by identifying ones of the specific user devices that are associated with the at least one user device.

16. The system according to claim 13, wherein the specific action taken with respect to a specific item of content include at least one of purchasing, recommending, sharing and lending the specific item of content.

17. The system according to claim 13, further comprising the plurality of user devices, the at least one user device comprising:
a device memory that includes instructions for operating the user device;
a display screen; and
device control circuitry coupled to the memory and coupled to the display screen, the device control circuitry executing the instructions and is operable to:
display the display data, the display data including a representation of respective specific items of content, respective actions taken with respect to the specific items of content and the geographic location of respective specific user devices.

18. The system according to claim 17, wherein device control circuitry executing the instructions is further operable to display the display data on a geographic map.

19. The system according to claim 17, wherein device control circuitry executing the instructions is further operable to display the display data as a list.

20. The system according to claim 17, wherein device control circuitry executing the instructions is further operable to animate the display data, wherein the animating, over time, highlights different representations of respective specific items of content, respective actions taken with respect to the specific items of content and the geographic location of respective specific user devices.

21. The system according to claim 17, wherein the control circuitry is in a remote central server and wherein device control circuitry executing the instructions is further operable to:
connect to the central server; and
access a shopping application, wherein the display of the display data occurs in association with the shopping application.

22. The system according to claim 21, wherein the central server is operable to:
receive a selection of one of the representation of respective specific items of content; and
perform a purchase transaction with respect to the selected specific item of content.

23. The system according to claim 21, wherein the central server further comprises:
a digital locker associated with the at least one user device, the digital locker storing a link to a copy of the purchased specific item of content.
